(19) United States
(12) Patent Application Publication
(10) Pub. No.: US 2022/0236528 A1
(43) Pub. Date: Jul. 28, 2022

(54) OPTICAL IMAGING SYSTEM, IMAGE CAPTURING APPARATUS, AND ELECTRONIC DEVICE

(71) Applicant: JIANGXI JINGCHAO OPTICAL CO., LTD., Nanchang (CN)

(72) Inventors: Han Xie, Nanchang (CN); Qi Song, Nanchang (CN); Ming Li, Nanchang (CN)

(21) Appl. No.: 17/719,581

(22) Filed: Apr. 13, 2022

Related U.S. Application Data
(63) Continuation of application No. PCT/CN2019/111499, filed on Oct. 16, 2019.

(51) Int. Cl. G02B 13/00; G02B 9/34

(52) U.S. Cl. CPC G02B 13/004; G02B 9/34

(57) ABSTRACT

An optical imaging system (100) includes, in order from an object side to an image side, a first lens (L1) with a positive refractive power, a second lens (L2) with a refractive power, a third lens (L3) with a refractive power, and a fourth lens (L4) with a refractive power. The optical imaging system (100) further includes a stop (10) located in front of an imaging surface of the optical imaging system (100), and a first infrared filter (31) located between the first lens (L1) and the fourth lens (L4). A filter is located in the middle of the optical imaging system (100), which leaves room for shortening a back focal length and facilitates ultra-thin design.

### CROSS-REFERENCE TO RELATED APPLICATIONS

This application is a continuation application of International Application No. PCT/CN2019/111499, filed Oct. 16, 2019, the entire disclosure of which is incorporated herein by reference.

### TECHNICAL FIELD

This application relates to the field of optical imaging technology, and more particularly to an optical imaging system, an image capturing apparatus, and an electronic device.

### BACKGROUND

With the widespread availability of portable mobile electronic products such as mobile phones and wearable devices, users have increasing requirements for miniaturization and thinness of such mobile electronic products, same as a shooting apparatus and camera lenses loaded thereon. As a size of a chip continuously reduces and the number of pixels continuously increases, requirements for resolution of the camera lens are also gradually increased. Thus, an ultra-thin and miniaturized camera lens with good optical performance is needed.

The present application adopts a four-piece optical imaging system, which ensures miniaturization of the camera lens. Such a small number of lenses uses aspherical surfaces to obtain different shapes, which can provide a good optical performance. In particular, for a camera lens packed through a chip-scale-package (CSP) manufacturing process, since there is usually a protective glass packed in front of a photosensitive chip, a filter in the present application is placed in the middle, which leaves room for shortening a back focal length and facilitates ultra-thin design. In addition, for some optical imaging systems with large lens spacing, the filter can be placed in the middle to reduce an assembly step, thereby improving a yield stability.

### SUMMARY

In view of above, a fourth-piece optical imaging system is provided, which can ensure miniaturization of the optical imaging system, reduce assembly steps (also called mismatch gaps) of various lenses of the optical imaging system, and improve a yield of the optical imaging system.

Also, it is necessary to provide an image capturing apparatus including the above-mentioned optical imaging system.

In addition, it is also necessary to provide an electronic device including the above-mentioned image capturing apparatus.

An optical imaging system, includes, in order from an object side to an image side, a first lens with a positive refractive power, a second lens with a refractive power, a third lens with a refractive power, and a fourth lens with a refractive power. The optical imaging system further includes a stop located in front of an imaging surface of the optical imaging system, and a first infrared filter located between the first lens and the fourth lens. As such, assembly steps among lenses of the optical imaging system can be reduced, and miniaturization can be realized.

In an implementation, an object-side surface and an image-side surface of each of the first lens, the second lens, the third lens, and the fourth lens are aspheric, and at least one of the object-side surface or the image-side surface of the fourth lens has at least one inflection point. The aspheric lenses are used to make it easy to obtain a shape other than a spherical shape and obtain more control variables, which is beneficial to reducing aberration and obtaining high-quality images with a relatively small number of lenses. As such, the number of the lenses can be reduced, and the miniaturization requirements of the optical imaging system can be satisfied. At least one of the object-side surface or the image-side surface of the fourth lens has at least one inflection point, with aid of the inflection point, it is possible to correct an aberration of an off-axis field of view, restrain an incident angle of light to the imaging surface, and match more accurately with a photosensitive element.

In an implementation, an object-side surface of the first lens is convex near an optical axis and a periphery. The object-side surface of the first lens is convex in the vicinity of the optical axis, which can improve the positive refractive power of the first lens that undertakes the main imaging function of the optical imaging system, and facilitates ultra-thinness.

In an implementation, an image-side surface of the second lens is concave near an optical axis and a periphery. The image-side surface of the second lens is concave, which facilitates a better spherical aberration correction.

In an implementation, an object-side surface of the third lens is concave near a periphery, and an image-side surface of the third lens is convex near a periphery. The third lens L3 can effectively reduce field curvature and distortion of the system and improve the imaging quality.

In an implementation, an object-side surface of the fourth lens is convex near the optical axis, and an image-side surface of the fourth lens is concave near the optical axis and is convex near a periphery. The image-side surface of the fourth lens is concave near the optical axis, which is beneficial to adjusting the back focal length. For the image-side surface of the fourth lens, a radius of curvature changes from concave to convex, to better correct the aberration of the off-axis field of view, restrain the incident angle of light to the imaging surface, and match more accurately with the photosensitive element.

In an implementation, the optical imaging system further includes a protective glass or a second infrared filter, where the protective glass or the second infrared filter is located between the fourth lens and the imaging surface. The protective glass is used for dustproof to protect the photosensitive element on the imaging surface. The second infrared filter is placed between the fourth lens and the imaging surface, which can filter out light in the infrared band, reduce some ghost images caused by stray light, and can also protect the photosensitive element to a certain extent.

In an implementation, the optical imaging system further includes a third infrared filter located in front of the first lens. The third infrared filter can cut off infrared light and reduce the adverse effect of infrared light on imaging. The third infrared filter is located in front of the first lens to match a new lens stacking form with a different lens barrel structure. At present, there is an assembly mode in which the first lens is finally assembled, the object-side surface of the first lens protrudes outside the lens barrel, and an infrared filter is placed in front of the first lens to protect a front end of the lens group.

In an implementation, the first infrared filter includes at least one first infrared filter.

In an implementation, the optical imaging system satisfies the following expression:

FNO>2.0;
where FNO represents an f-number of the optical imaging system.

If FNO<2.0, the optical imaging system is most likely to be a high-end imaging product, which has higher requirements for imaging quality, and the optical imaging system generally has a compact multi-piece structure, which makes it difficult to place the infrared filter in the middle. However, the present application can still be applied to other products with FNO<2.0, especially for products manufactured through a CSP process, placing the infrared filter in the middle is more beneficial to compressing a total length of the optical imaging system.

In an implementation, the optical imaging system satisfies the following expression:

BF/TTL<0.21;
where BF represents a minimum distance from an image-side surface of the fourth lens to the imaging surface of the optical imaging system in a direction parallel to an optical axis, and TTL represents a distance from an object-side surface of the first lens to the imaging surface on the optical axis.

Usually, a filter and a complementary metal-oxide semiconductor (CMOS) photosensitive chip are also sequentially provided at an image side of the last lens of the optical imaging system (for example, the fourth lens in the present application). Light is first filtered by the filter before incident on the photosensitive chip, so the filter has a certain protective effect on the photosensitive chip, and also filters part of the light, which reduces stray light and light spots, etc. and makes the image have bright and sharp colors and good color reproduction. Generally, a few-piece optical imaging system has low pixels, and the infrared filter can be located in the middle for some specifications with low imaging requirements. In addition, a protective glass is packaged in front of a photosensitive chip of the product manufactured through the CSP process, and the infrared filter can be placed in the middle to leave room for compressing the back focus, which facilitates the ultra-thinness and miniaturization of the optical imaging system.

In an implementation, the optical imaging system satisfies the following expression:

MAX(T12:T23:T34)>0.4;
where T12 represents a distance from an image-side surface of the first lens to an object-side surface of the second lens on an optical axis, T23 represents a distance from an image-side surface of the second lens to an object-side surface of the third lens on the optical axis, T34 represents a distance from an image-side surface of the third lens to an object-side surface of the fourth lens on the optical axis, and MAX(T12:T23:T34) represents a maximum among T12, 123, and T34.

When the above expression is satisfied, each of the lenses in the optical imaging system is spaced apart from one another at a large interval, the assembly step is large, a mass production assembly is unstable, and the yield is poor. If an infrared filter is placed between lenses arranged at large intervals, the assembly step can be reduced, the yield can be improved, and a space can be saved for a mechanical back focus of the lens, which is beneficial to compressing a height of a camera lens.

In an implementation, the optical imaging system satisfies the following expression:

0.5<f1/f<1.3;
where f represents an effective focal length of the optical imaging system, and f1 represents an effective focal length of the first lens.

Since the first lens L1 is responsible for most of a positive refractive power of the optical imaging system, a reasonable positive refractive power of the first lens L1 is more beneficial to shortening the optical imaging system and can effectively correct field curvature of the optical imaging system.

In an implementation, the optical imaging system satisfies the following expression:

R1/f>0.4;
where R1 represents a radius of curvature of an object-side surface of the first lens, and f represents a total effective focal length of the optical imaging system.

The object-side surface of the first lens L1 is convex in the vicinity of the optical axis, which can improve the positive refractive power of the first lens L1 that undertakes the main imaging function of the optical imaging system 100, and facilitates ultra-thinness. If R1/f is lower than a lower limit, the positive refractive power of the first lens L1 is excessively large relative to the entire optical imaging system, which makes an aberration correction difficult.

In an implementation, the optical imaging system satisfies the following expression:

3<D/CT4<15;
where D represents an optical clear aperture of an image-side surface of the fourth lens, and CT4 represents a distance from an object-side surface of the fourth lens to the image-side surface of the fourth lens on an optical axis.

When the lens has a small thickness and a large outer diameter, the molding is difficult to be uniform, and it is easy to produce joint lines. When the above expression is satisfied, the fourth lens can be easily injection-molded, so that the plastic injected via a unilateral gate can easily reach the opposite side, which lowers an eccentricity of the lens and improves the yield of the optical imaging system.

In an implementation, the optical imaging system satisfies the following expression:

0.12<|(R7−R8)/(R7+R8)|<0.51;
where R7 represents a radius of curvature of an object-side surface of the fourth lens, and R8 represents a radius of curvature of an image-side surface of the fourth lens.

In an implementation, at least one of the second lens, the third lens, or the fourth lens has a negative refractive power. At least one of the second lens, the third lens, or the fourth lens has a negative refractive power, which can correct the spherical aberration caused by the positive refractive power of the first lens, and cooperates with other lenses to ensure a higher resolution of the optical imaging system.

By reasonable configuring radii of curvature of the object-side surface and the image-side surface of the fourth lens, the total optical length for imaging can be effectively shortened, which satisfies miniaturization requirements, and effectively improves the resolution of the optical imaging system.

An image capturing apparatus is further provided in the present application. The image capturing apparatus includes the above-mentioned optical imaging system and a photosensitive element located on the imaging surface of the optical imaging system.

An electronic device is further provided in the present application. The electronic device includes a body and the above-mentioned image capturing apparatus, where the image capturing apparatus is installed on the body.

Thus, the present application adopts a four-piece optical imaging system with the first infrared filter between the first lens and the fourth lens. As such, miniaturization of the optical imaging system is realized, the assembly step of the optical imaging system is reduced, and assembly stability of the optical imaging system is improved, which improves the yield of the optical imaging system and lows a cost.

### BRIEF DESCRIPTION OF THE DRAWINGS

Structures, features, and functions of the present application are more clearly described hereinafter with reference to the accompanying drawings and the implementations.

FIG. 1 is a schematic structural view of an optical imaging system according to an implementation of the present application.

FIG. 2 illustrates from left to right a spherical aberration curve, an astigmatic curve, and a distortion curve of the optical imaging system illustrated in FIG. 1.

FIG. 3 is a schematic structural view of an optical imaging system according to an implementation of the present application.

FIG. 4 illustrates from left to right a spherical aberration curve, an astigmatic curve, and a distortion curve of the optical imaging system illustrated in FIG. 3.

FIG. 5 is a schematic structural view of an optical imaging system according to an implementation of the present application.

FIG. 6 illustrates from left to right a spherical aberration curve, an astigmatic curve, and a distortion curve of the optical imaging system illustrated in FIG. 5.

FIG. 7 is a schematic structural view of an optical imaging system according to an implementation of the present application.

FIG. 8 illustrates from left to right a spherical aberration curve, an astigmatic curve, and a distortion curve of the optical imaging system illustrated in FIG. 7.

FIG. 9 is a schematic structural view of an optical imaging system according to an implementation of the present application.

FIG. 10 illustrates from left to right a spherical aberration curve, an astigmatic curve, and a distortion curve of the optical imaging system illustrated in FIG. 9.

FIG. 11 is a schematic structural view of an optical imaging system according to an implementation of the present application.

FIG. 12 illustrates from left to right a spherical aberration curve, an astigmatic curve, and a distortion curve of the optical imaging system illustrated in FIG. 11.

FIG. 13 is a schematic structural view of an image capturing apparatus according to an implementation of a second aspect of the present application.

FIG. 14 is a schematic structural view of an electronic device according to an implementation of a third aspect of the present application.

### DETAILED DESCRIPTION

Technical solutions in implementations of the present application will be described clearly and completely hereinafter with reference to the accompanying drawings in the implementations of the present application. Apparently, the described implementations are merely some rather than all implementations of the present application. All other implementations obtained by those of ordinary skill in the art based on the implementations of the present application without creative efforts shall fall within the protection scope of the present application.

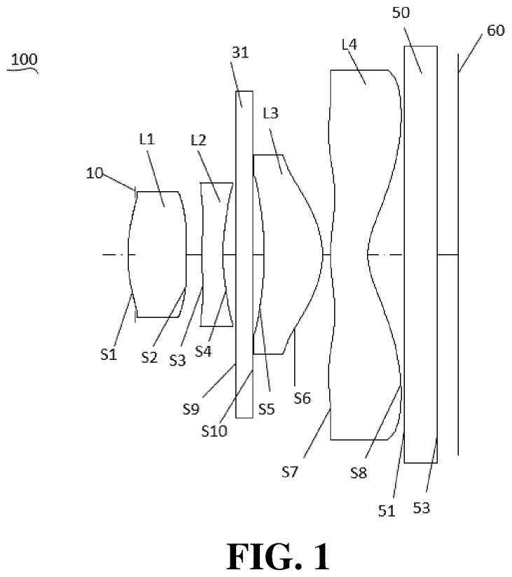

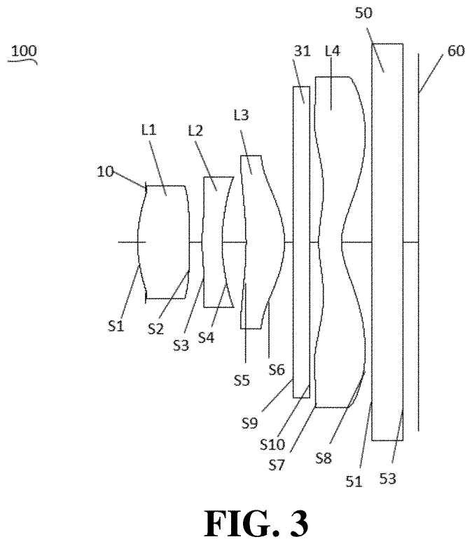

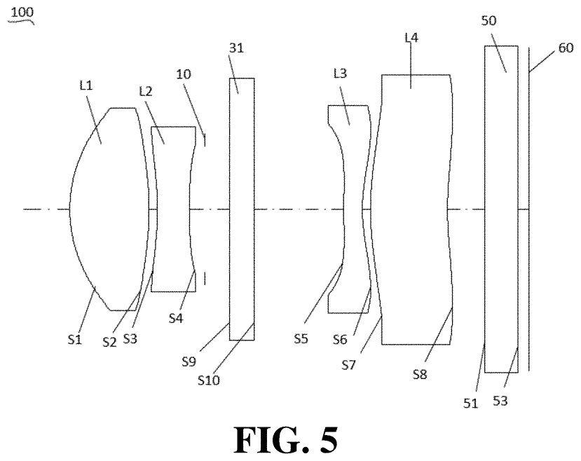

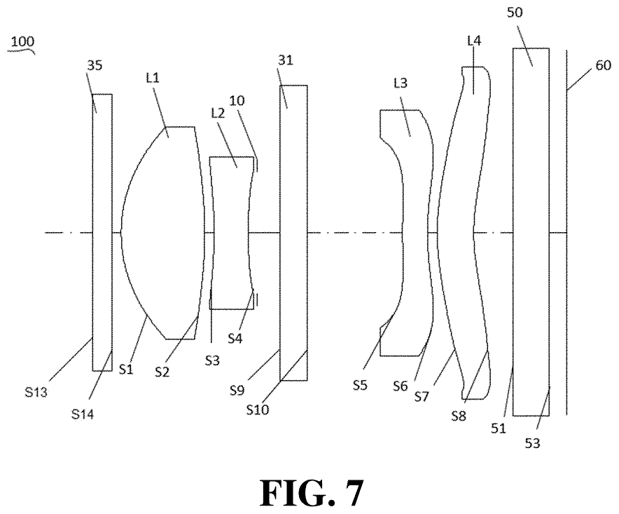

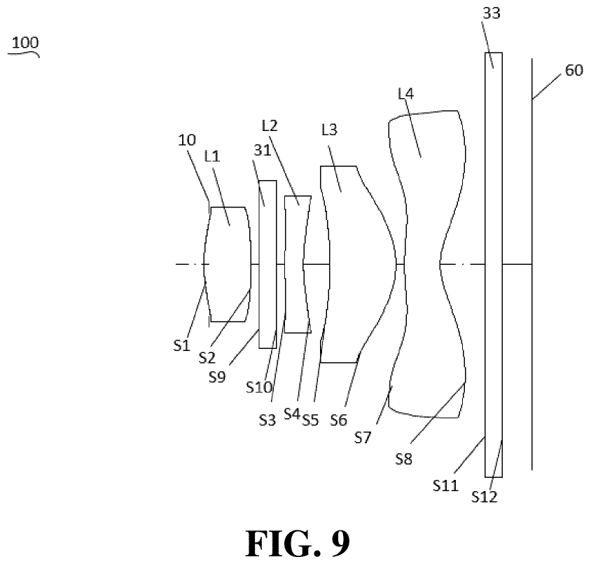

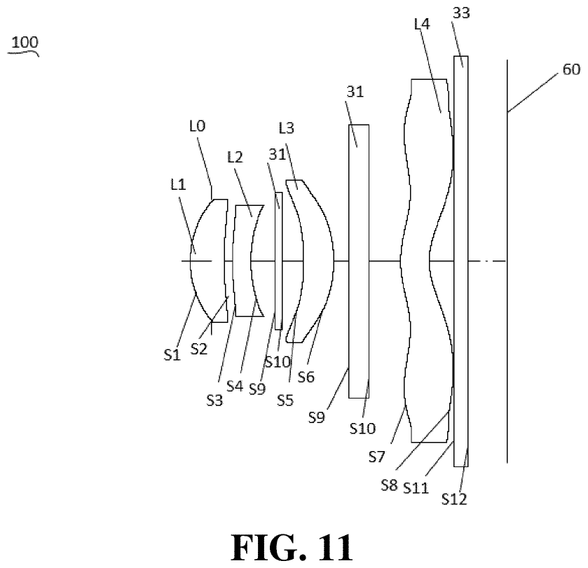

Referring to FIG. 1, FIG. 3, FIG. 5, FIG. 7, FIG. 9, and FIG. 11, an optical imaging system 100 provided in a first aspect of the present application is applied to a camera lens. The optical imaging system 100 includes, in order from an object side to an image side, a first lens L1 with a positive refractive power, a second lens L2 with a refractive power, a third lens L3 with a refractive power, and a fourth lens L4 with a refractive power. The optical imaging system 100 further includes a stop 10 and a first infrared filter 31. The stop 10 is located in front of an imaging surface of the optical imaging system 100. The first infrared filter 31 is located between the first lens L1 and the fourth lens L4.

Optionally, the first lens L1 is made of plastic and has an object-side surface S1 and an image-side surface S2. The object-side surface S1 and the image-side surface S2 of the first lens L1 are aspheric. The object-side surface S1 of the first lens L1 is convex near an optical axis and a periphery. The image-side surface S2 of the first lens L1 can be convex or concave near the optical axis and can be convex or concave near a periphery. The first lens L1 is an aspheric lens, which can facilitate light converging and image formation. It is easy to form other shapes other than a spherical shape, obtain more control variables, and obtain a high-quality image with fewer lenses, which reduces the number of the lenses and satisfies miniaturization requirements.

Optionally, the second lens L2 is made of plastic and has an object-side surface S3 and an image-side surface S4. The object-side surface S3 and the image-side surface S4 of the second lens L2 are aspheric. The object-side surface S3 of the second lens L2 can be convex or concave near the optical axis and can be convex or concave near a periphery. The image-side surface S4 of the second lens L2 is convex near the optical axis and a periphery. The second lens L2 can have a positive refractive power or a negative refractive power. The second lens L2 is an aspheric lens, it is easy to form other shapes other than the spherical shape and obtain more control over the variables, which is beneficial to reducing the aberration and obtaining the high-quality image with fewer lenses. As such, the number of the lenses can be reduced, and the miniaturization requirements of the optical imaging system can be satisfied. The image-side surface S4 of the second lens L2 is concave, which facilitates a spherical aberration correction.

Optionally, the third lens L3 is made of plastic and has an object-side surface S5 and an image-side surface S6. The object-side surface S5 and the image-side surface S6 of the third lens L3 are aspheric. The object-side surface S5 of the third lens L3 can be convex or concave near the optical axis and can be concave near a periphery. The image-side surface S6 of the third lens L3 can be convex or concave near the optical axis and can be convex near a periphery. The third lens L3 can have a positive refractive power or a negative refractive power. The third lens L3 can effectively reduce field curvature and distortion of the optical imaging system and improve imaging quality. The third lens L3 is an aspheric lens, it is easy to form other shapes other than the spherical shape and obtain more control over the variables, which is beneficial to reducing the aberration and obtaining the high-quality image with fewer lenses. As such, the number of the lenses can be reduced, and the miniaturization requirements of the optical imaging system can be satisfied.

Optionally, the fourth lens L4 is made of plastic and has an object-side surface S7 and an image-side surface S8. The object-side surface S7 and the image-side surface S8 of the fourth lens L4 are aspheric. The object-side surface S7 of the fourth lens L4 is convex near the optical axis and can be convex or concave near a periphery. The image-side surface S8 of the fourth lens L4 is concave near the optical axis and is convex near a periphery. The fourth lens L4 can have a positive refractive power or a negative refractive power. The image-side surface of the fourth lens is concave near the optical axis, which is beneficial to adjusting the back focal length. For the image-side surface of the fourth lens, a radius of curvature changes from concave to convex, to better correct the aberration of the off-axis field of view, restrain the incident angle of light to the imaging surface, and match more accurately with the photosensitive element.

Optionally, at least one of the second lens L2, the third lens L3, or the fourth lens L4 has a negative refractive power. At least one of the second lens L2, the third lens L3, or the fourth lens L4 has a negative refractive power, which can correct the spherical aberration caused by the positive refractive power of the first lens, and cooperates with other lenses to ensure a higher resolution of the optical imaging system.

Optionally, the stop 10 can be located at any position in the optical imaging system 100. The stop 10 can be located on the object-side surface of the first lens L1, or between the second lens L2 and the third lens L3, or between the third lens L3 and the fourth lens L4, etc.

Optionally, the infrared filter 31 is made of glass and has an object-side surface S9 and an image-side surface S10. The object-side surface S9 and the image-side surface S10 of the infrared filter 31 are spheric. The first infrared filter 31 may be located at any position between the first lens L1 and the second lens L4. More specifically, as illustrated in FIG. 9, the first infrared filter 31 is located between the first lens and the second lens; or as illustrated in FIGS. 1, 5, 7, and 11, the first infrared filter 31 is located between the second lens and the third lens; or as illustrated in FIG. 3, the first infrared filter 31 is located between the third lens and the fourth lens. The first infrared filter 31 can include at least one first infrared filter 31. More specifically, the first infrared filter 31 can include one first infrared filter 31 (as illustrated in FIGS. 1, 3, 5, 7, and 9), or two first infrared filters 31 (as illustrated in FIG. 11), or three first infrared filters 31. The infrared filter is usually located in front of a photosensitive element to filter out light with a wavelength different from that of visible light and reduce or eliminate a ghost image, stray light, and other adverse factor to the image. In the present application, the infrared filter is located in the middle, instead the rear, of the optical imaging system to reduce the mechanical back focal length of the camera lens, which is beneficial to realizing the miniaturization design. The filter is located between two adjacent lenses with a large air gap therebetween, such that various elements are compactly assembled together, a bearing step is reduced, and an actual production yield is more stable.

The term “element” in the present application refers to a lens, a lens barrel, a light shielding sheet, a gasket of a camera, or a component of other lens products.

The term “ghost image” in the present application refers to a duplicate image formed in the vicinity of a focal plane of the optical imaging system caused by reflections from lens surfaces, which is dim and offset with an original image.

In the four-piece optical imaging system 100 of the present application, the first infrared filter 30 is located between the first lens L1 and the fourth lens L4, the miniaturization of the optical imaging system 100 is achieved, the assembly step of the optical imaging system 100 is reduced, and assembly stability of the optical imaging system 100 can be improved. As such, the yield of the optical imaging system 100 is improved and the cost is lowered.

In some implementations, at least one of the object-side surface S7 or the image-side surface S8 has at least one inflection point. The inflection point refers to a point where a radius of curvature changes from being negative to positive or from being positive to negative. The inflection point can be used to correct the aberration of an off-axis field of view and restrain an incident angle of light to an imaging surface so as to match the photosensitive element more precisely.

In some implementations, the optical imaging system 100 of the present application further includes a protective glass 50 or a second infrared filter 33, where the protective glass 50 or the second infrared filter 33 is located between the fourth lens L4 and the imaging surface 60. The protective glass 50 is used for dustproof to protect photosensitive elements on the imaging surface 60. The protective glass 50 has an object-side surface 51 and an image-side surface 53. The second infrared filter 33 has an object-side surface S11 and an image-side surface S12, which can filter out light in the infrared band, reduce some ghost images caused by stray light, and can also protect the photosensitive element to a certain extent

In some implementations, the optical imaging system 100 of the present application further includes a third infrared filter 35 located in front of the first lens L1. The third infrared filter 35 has an object-side surface S13 and an image-side surface S14. The third infrared filter can cut off infrared light and reduce the adverse effect of infrared light on imaging. The third infrared filter is located in front of the first lens to match a new lens stacking form with a different lens barrel structure. At present, there is an assembly mode in which the first lens is finally assembled, the object-side surface of the first lens protrudes outside the lens barrel, and an infrared filter is placed in front of the first lens to protect a front end of the lens group.

In some implementations, the optical imaging system 100 satisfies the following expression:

FNO>2.0;
where FNO represents an f-number of the optical imaging system.

In other words, FNO may be any value greater than 2.0. For example, FNO may be 2.0, 2.5, 3.0, 4.0, etc.

If FNO<2.0, the optical imaging system 100 is most likely to be a high-end imaging product, which has higher requirements for imaging quality, and the optical imaging system 100 generally has a compact multi-piece structure, which makes it difficult to place the infrared filter in the middle. However, the present application can still be applied to other products with FNO<2.0, especially for products manufactured through a CSP process, placing the infrared filter in the middle is more beneficial to compressing a total length of the optical imaging system 100.

In some implementations, the optical imaging system 100 satisfies the following expression:

BF/TTL<0.21;
where BF represents a minimum distance from an image-side surface of the fourth lens to the imaging surface of the optical imaging system in a direction parallel to an optical axis, and TTL represents a distance from an object-side surface of the first lens to the imaging surface on the optical axis.

In other words, BF/TTL may be any value ranging from 0 to 0.21. For example, BF/TTL may be 0.1, 0.15, 0.18, 0.2, etc.

Usually, a filter and a complementary metal-oxide semiconductor (CMOS) photosensitive chip are also sequentially provided at an image side of the last lens of the optical imaging system (for example, the fourth lens L4 in the present application). Light is first filtered by the filter before incident on the photosensitive chip, so the filter has a certain protective effect on the photosensitive chip, and also filters part of the light, which reduces stray light and light spots, etc. and makes the image have bright and sharp colors and good color reproduction. Generally, a few-piece optical imaging system has low pixels, and the infrared filter can be located in the middle for some specifications with low imaging requirements. In addition, a protective glass is packaged in front of a photosensitive chip of the product manufactured through the CSP process, and placing the infrared filter in the middle can leave room for compressing the back focus, which facilitates the ultra-thinness and miniaturization of the optical imaging system.

In some implementations, the optical imaging system 100 satisfies the following expression:

MAX(T12:T23:T34)>0.4;
where T12 represents a distance from an image-side surface of the first lens to an object-side surface of the second lens on an optical axis, T23 represents a distance from an image-side surface of the second lens to an object-side surface of the third lens on the optical axis, T34 represents a distance from an image-side surface of the third lens to an object-side surface of the fourth lens on the optical axis, and MAX(T12:T23:T34) represents a maximum among T12, 123, and T34.

In other words, MAX(T12:T23:T34) may be any value greater than 0.4. For example, FNO may be 0.5, 0.8, 1.0, 1.5, 1.8, etc.

When the above expression is satisfied, each of the lenses in the optical imaging system 100 is spaced apart from one another at a large interval, the assembly step is large, a mass production assembly is easily unstable, and the yield is poor. If an infrared filter is placed between lenses arranged at large intervals, the assembly step can be reduced, the yield can be improved, and a space can be saved for a mechanical back focus, which is beneficial to compressing a height of a camera lens.

In some implementations, the optical imaging system 100 satisfies the following expression:

0.5<f1/f<1.3;
where f represents an effective focal length of the optical imaging system, and f1 represents an effective focal length of the first lens.

In other words, f1/f may be any value ranging from 0.5 to 1.3. For example, FNO may be 0.6, 0.8, 1.0, 1.1, 1.2, etc.

Since the first lens L1 is responsible for most of a positive refractive power of the optical imaging system, a reasonable positive refractive power of the first lens L1 is more beneficial to shortening the optical imaging system 100 and can effectively correct field curvature of the optical imaging system.

In some implementations, the optical imaging system satisfies the following expression:

R1/f>0.4;
where R1 represents a radius of curvature of an object-side surface of the first lens, and f represents a total effective focal length of the optical imaging system.

In other words, R1/f may be any value greater than 0.4. For example, R1/f may be 0.5, 0.8, 1.0, 1.5, 1.8, etc.

The object-side surface of the first lens L1 is convex in the vicinity of the optical axis, which can improve the positive refractive power of the first lens L1 that undertakes the main imaging function of the optical imaging system 100, and facilitates ultra-thinness. If R1/f is lower than a lower limit, the positive refractive power of the first lens L1 is excessively large relative to the entire optical imaging system 100, which makes an aberration correction difficult.

In some implementations, the optical imaging system 100 satisfies the following expression:

3<D/CT4<15;
where D represents an optical clear aperture of an image-side surface of the fourth lens, and CT4 represents a distance from an object-side surface of the fourth lens to the image-side surface of the fourth lens on an optical axis.

In other words, D/CT4 may be any value ranging from 3 to 15. For example, D/CT4 may be 4, 5, 6, 7, 8, 10, 12, 15, etc.

When the lens has a small thickness and a large outer diameter, the molding is difficult to be uniform, and it is easy to produce joint lines. When the above expression is satisfied, the fourth lens L4 can be easily injection-molded, so that the plastic injected via a unilateral gate can easily reach the opposite side, which lowers an eccentricity of the lens and improves the yield of the optical imaging system.

In some implementations, the optical imaging system 100 satisfies the following expression:

0.12<|(R7−R8)/(R7+R8)|<0.51;
where R7 represents a radius of curvature of an object-side surface of the fourth lens, and R8 represents a radius of curvature of an image-side surface of the fourth lens.

In other words, |(R7−R8)/(R7+R8)| may be any value ranging from 0.12 to 0.51. For example, |(R7−R8)/(R7+R8)| may be 0.15, 0.18, 0.2, 0.3, 0.4, 0.5, etc.

By reasonable configuring radii of curvature of the object-side surface and the image-side surface of the fourth lens L4, the total optical length for imaging can be effectively shortened, which satisfies miniaturization requirements, and effectively improves the resolution of the optical imaging system 100.

The optical imaging system 100 of the present application will be further specifically described hereinafter with reference to several implementations.

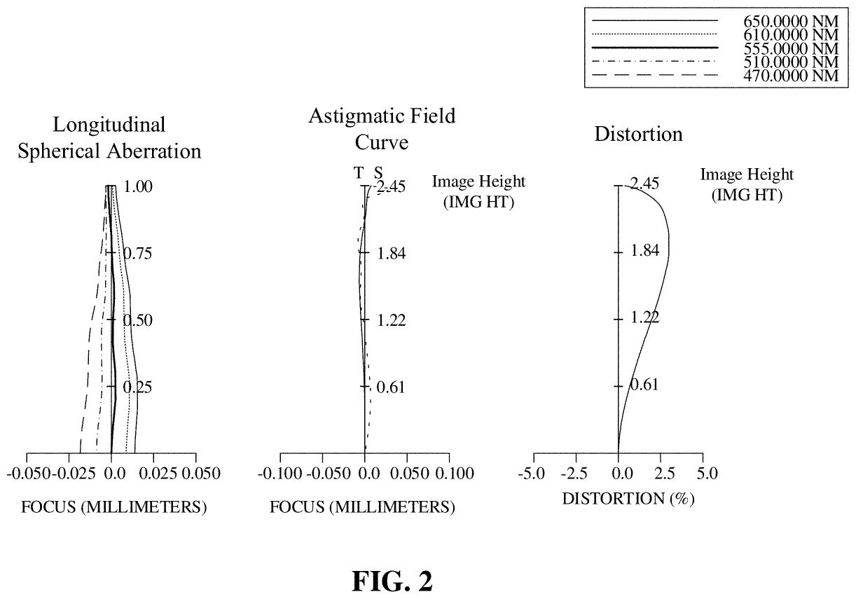

Referring to FIG. 1 and FIG. 2, FIG. 1 is a schematic structural view of an optical imaging system 100 according to an implementation of the present application. FIG. 2 illustrates from left to right a spherical aberration curve, an astigmatic curve, and a distortion curve of the optical imaging system 100 illustrated in FIG. 1. As illustrated in FIG. 1, the optical imaging system 100 of this implementation includes, from an object side to an image side, a first lens L1 with a positive refractive power, a second lens L2 with a negative refractive power, a first infrared filter 31, a third lens L3 with a positive refractive power, a fourth lens L4 with a negative refractive power, a protective glass 50, and an imaging surface 60. The optical imaging system 100 further includes a stop 10. The stop 10 is located at an object side of the first lens L1.

The first lens L1 is made of plastic. An object-side surface S1 and an image-side surface S2 of the first lens L1 are aspheric. The object-side surface S1 is convex near the optical axis and a periphery. The image-side surface S2 is convex near the optical axis and a periphery.

The second lens L2 is made of plastic. An object-side surface S3 and an image-side surface S4 of the second lens L2 are aspheric. The object-side surface S3 is convex near the optical axis and is concave near a periphery. The image-side surface S4 is concave near the optical axis and a periphery.

The third lens L3 is made of plastic. An object-side surface S5 and an image-side surface S6 of the third lens L3 are aspheric. The object-side surface S5 is concave near the optical axis and a periphery. The image-side surface S6 is convex near the optical axis and a periphery.

The fourth lens L4 is made of plastic. An object-side surface S7 and an image-side surface S8 of the fourth lens L4 are aspheric. The object-side surface S7 is convex near the optical axis and a periphery. The image-side surface S8 is concave near the optical axis and is convex near a periphery.

In this implementation, FNO=2.09. BF=0.7, TTL=4.072, BF/TTL=0.172. MAX(T12:T23:T34)=0.509. f1=3.141, f=3.875, f1/f=0.811. R1=1.902, R1/f=0.491. D=4.526, CT4=0.459, D/CT4=9.861. R7=1.87, R8=0.705, |(R7−R8)/(R7+R8)|=0.452.

In this implementation, the optical imaging system 100 satisfies conditions in Table 1 and Table 2 below.

TABLE 1
Optical Imaging System 100 illustrated in FIG. 1
EFL = 3.875, FNO = 2.09, FOV = 80.2, TTL = 4.072

| Surface | Surface | Surface | Y | | | Refractive | Abbe | Focal |
|---|---|---|---|---|---|---|---|---|
| Number | name | type | Radius | Thickness | Material | index | number | length |
| Object surface | | Spheric | Infinity | 400 | | | | |
| Stop 10 | | Spheric | Infinity | −0.093 | | | | |
| S1 | First Lens | Aspheric | 1.902 | 0.723 | Plastic | 1.544 | 56.114 | 3.141 |
| S2 | | Aspheric | −15.055 | 0.191 | | | | |
| S3 | Second Lens | Aspheric | 3.545 | 0.259 | Plastic | 1.661 | 20.370 | −8.975 |
| S4 | | Aspheric | 2.161 | 0.157 | | | | |
| S9 | First Infrared | Spheric | Infinity | 0.210 | Glass | 1.517 | 64.167 | |
| S10 | Filter | Spheric | Infinity | 0.142 | | | | |
| S5 | Third Lens | Aspheric | −3.508 | 0.720 | Plastic | 1.544 | 56.114 | 2.278 |
| S6 | | Aspheric | −0.985 | 0.100 | | | | |
| S7 | Fourth Lens | Aspheric | 1.870 | 0.459 | Plastic | 1.544 | 56.114 | −2.408 |
| S8 | | Aspheric | 0.705 | 0.453 | | | | |
| S51 | Protective | Spheric | Infinity | 0.400 | Glass | 1.517 | 64.167 | |
| S53 | Glass | Spheric | Infinity | 0.258 | | | | |
| Imaging Surface | | Spheric | Infinity | 400 | | | | |

Note:
a reference wavelength is d-line 555.0 nm

TABLE 2
Aspheric Coefficients of the Optical Imaging System 100 Illustrated in FIG. 1
Aspheric Coefficients

| Surface | | | | | | | | |
|---|---|---|---|---|---|---|---|---|
| Number | S1 | S2 | S3 | S4 | S5 | S6 | S7 | S8 |
| K | 7.8062E−01 | −9.9000E+01 | −7.0815E+00 | 1.9399E+00 | 1.0634E+01 | −4.4082E+00 | −1.5657E+01 | −3.6421E+00 |
| A4 | −6.7783E−02 | −2.8649E−01 | −3.9106E−01 | −2.0655E−01 | 1.5361E−01 | −2.7436E−01 | −2.5745E−01 | −2.0361E−01 |
| A6 | 2.9714E−02 | −2.8555E−03 | 2.0562E−01 | −1.9270E−01 | −4.4723E−01 | 5.9691E−01 | 2.0872E−01 | 1.9936E−01 |
| A8 | −2.6177E−01 | 1.8075E+00 | −1.3912E+00 | 1.5264E+00 | 1.6442E+00 | −1.2585E+00 | −1.6819E−01 | −1.4986E−01 |
| A10 | −4.9597E+00 | −1.4326E+01 | 1.0549E+01 | −5.4394E+00 | −5.0134E+00 | 2.1079E+00 | 1.3915E−01 | 8.0659E−02 |
| A12 | 5.1636E+01 | 5.9842E+01 | −3.8954E+01 | 1.5159E+01 | 1.1044E+01 | −2.5297E+00 | −7.9866E−02 | −2.9783E−02 |
| A14 | −2.2538E+02 | −1.4445E+02 | 8.8647E+01 | −2.8340E+01 | −1.5752E+01 | 2.1192E+00 | 2.8813E−02 | 7.2651E−03 |
| A16 | 5.1550E+02 | 2.0051E+02 | −1.2306E+02 | 3.2219E+01 | 1.3901E+01 | −1.1102E+00 | −6.3430E−03 | −1.1120E−03 |
| A18 | −6.0650E+02 | −1.4733E+02 | 9.4699E+01 | −2.0123E+01 | −6.9282E+00 | 3.1042E−01 | 7.8481E−04 | 9.6575E−05 |
| A20 | 2.8989E+02 | 4.3802E+01 | −3.0841E+01 | 5.3103E+00 | 1.4874E+00 | −3.4026E−02 | −4.2042E−05 | −3.6403E−06 |

Table 2 illustrates aspherical data of the optical imaging system 100 illustrated in FIG. 1, where k represents a conic coefficient of each surface. A4 to A20 represent the fourth to twentieth order aspherical coefficients of each surface.

As illustrated in FIG. 2, an aberration of the optical imaging system 100 of the present application is still be controlled within a reasonable range on the premise of satisfying ultra-thinness and miniaturization, which ensures the imaging quality.

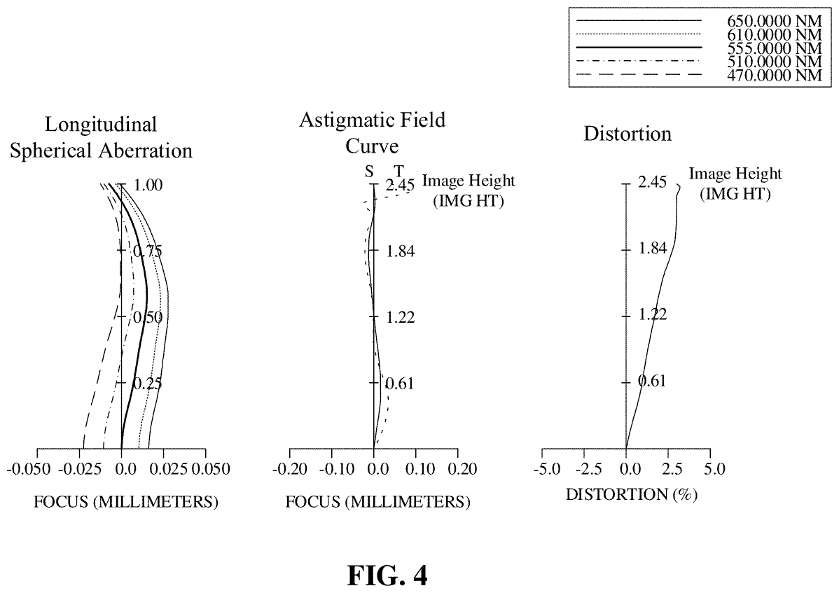

Referring to FIG. 3 and FIG. 4, FIG. 3 is a schematic structural view of an optical imaging system 100 according to an implementation of the present application. FIG. 4 illustrates from left to right a spherical aberration curve, an astigmatic curve, and a distortion curve of the optical imaging system 100 illustrated in FIG. 3. As illustrated in FIG. 3, the optical imaging system 100 of this implementation includes, from an object side to an image side, a first lens L1 with a positive refractive power, a second lens L2 with a negative refractive power, a third lens L3 with a positive refractive power, a first infrared filter 31, a fourth lens L4 with a negative refractive power, a protective glass 50, and an imaging surface 60. The optical imaging system 100 further includes a stop 10. The stop 10 is located at an object side of the first lens L1.

The first lens L1 is made of plastic. An object-side surface S1 and an image-side surface S2 of the first lens L1 are aspheric. The object-side surface S1 is convex near the optical axis and a periphery. The image-side surface S2 is concave near the optical axis and is convex near a periphery.

The second lens L2 is made of plastic. An object-side surface S3 and an image-side surface S4 of the second lens L2 are aspheric. The object-side surface S3 is convex near the optical axis and a periphery. The image-side surface S4 is concave near the optical axis and a periphery.

The third lens L3 is made of plastic. An object-side surface S5 and an image-side surface S6 of the third lens L3 are aspheric. The object-side surface S5 is concave near the optical axis and a periphery. The image-side surface S6 is convex near the optical axis and a periphery.

The fourth lens L4 is made of plastic. An object-side surface S7 and an image-side surface S8 of the fourth lens L4 are aspheric. The object-side surface S7 is convex near the optical axis and is concave near a periphery. The image-side surface S8 is concave near the optical axis and is convex near a periphery.

In this implementation, FNO=2.09. BF=0.7, TTL=3.687, BF/TTL=0.190. MAX(T12:T23:T34)=0.451. f1=3.394, f=2.73, f1/f=1.243. R1=1.696, R1/f=0.621. D=4.296, CT4=0.298, D/CT4=14.416. R7=1.404, R8=0.7, |(R7−R8)/(R7+R8)|=0.335.

In this implementation, the optical imaging system 100 satisfies conditions in Table 3 and Table 4 below.

TABLE 3
Optical Imaging System 100 Illustrated in FIG. 3
EFL = 2.73, FNO = 2.09, FOV = 81.6, TTL = 3.687

| Surface | Surface | Surface | Y | | | Refractive | Abbe | Focal |
|---|---|---|---|---|---|---|---|---|
| Number | name | type | Radius | Thickness | Material | index | number | length |
| Object surface | | Spheric | Infinity | Infinity | | | | |
| Stop 10 | | Spheric | Infinity | −0.103 | | | | |
| S1 | First Lens | Aspheric | 1.696 | 0.673 | Plastic | 1.544 | 56.114 | 3.394 |
| S2 | | Aspheric | 17.226 | 0.174 | | | | |
| S3 | Second Lens | Aspheric | 2.541 | 0.260 | Plastic | 1.661 | 20.370 | −13.345 |
| S4 | | Aspheric | 1.895 | 0.318 | | | | |
| S5 | Third Lens | Aspheric | −3.764 | 0.502 | Plastic | 1.544 | 56.114 | 2.805 |
| S6 | | Aspheric | −1.140 | 0.120 | | | | |
| S9 | First Infrared | Spheric | Infinity | 0.210 | Glass | 1.517 | 64.167 | |
| S10 | Filter | Spheric | Infinity | 0.120 | | | | |
| S7 | Fourth Lens | Aspheric | 1.404 | 0.298 | Plastic | 1.544 | 56.114 | −3.009 |
| S8 | | Aspheric | 0.700 | 0.404 | | | | |
| S51 | Protective | Spheric | Infinity | 0.400 | Glass | 1.517 | 64.167 | |
| S53 | Glass | Spheric | Infinity | 0.208 | | | | |
| Imaging Surface | | Spheric | Infinity | 0.000 | | | | |

Note:
a reference wavelength is d-line 555.0 nm

TABLE 4
Aspheric Coefficients of the Optical Imaging System 100 illustrated in FIG. 3
Aspheric Coefficients

| Surface | | | | | | | | |
|---|---|---|---|---|---|---|---|---|
| Number | S1 | S2 | S3 | S4 | S5 | S6 | S7 | S8 |
| K | 7.7077E−01 | −9.8416E+01 | −4.2755E+00 | 1.9875E+00 | 1.0186E+01 | −7.3324E+00 | −1.8771E+01 | −4.3398E+00 |
| A4 | −7.6455E−02 | −2.6112E−01 | −3.2914E−01 | −2.2306E−01 | −1.6670E−02 | −4.7769E−01 | −2.4323E−01 | −2.0552E−01 |
| A6 | 3.0145E−01 | −3.1826E−01 | −3.4642E−01 | 1.9737E−01 | 1.4407E+00 | 1.7617E+00 | 1.2415E−01 | 1.7655E−01 |
| A8 | −4.7004E+00 | 4.1486E+00 | 2.8487E+00 | −2.1762E+00 | −7.6878E+00 | −5.0706E+00 | −8.6360E−03 | −1.1561E−01 |
| A10 | 3.3652E+01 | −2.4774E+01 | −1.4053E+01 | 1.1304E+01 | 2.4578E+01 | 1.1353E+01 | −1.6597E−02 | 5.1397E−02 |
| A12 | −1.4313E+02 | 8.9866E+01 | 5.3270E+01 | −3.1988E+01 | −5.0454E+01 | −1.7556E+01 | 5.3132E−03 | −1.3678E−02 |
| A14 | 3.6478E+02 | −1.9804E+02 | −1.1932E+02 | 5.9688E+01 | 6.6096E+01 | 1.7755E+01 | 1.7787E−03 | 1.6198E−03 |
| A16 | −5.4342E+02 | 2.5477E+02 | 1.5022E+02 | −7.2306E+01 | −5.2516E+01 | −1.1020E+01 | −1.4301E−03 | 7.6500E−05 |
| A18 | 4.2948E+02 | −1.7408E+02 | −9.8973E+01 | 5.0353E+01 | 2.2666E+01 | 3.7613E+00 | 3.1748E−04 | −3.8350E−05 |
| A20 | −1.3575E+02 | 4.8133E+01 | 2.6550E+01 | −1.5038E+01 | −3.9981E+00 | −5.3674E−01 | −2.4562E−05 | 2.6445E−06 |

Table 4 illustrates aspherical data of the optical imaging system 100 illustrated in FIG. 3, where k represents a conic coefficient of each surface. A4 to A20 represent the fourth to twentieth order aspherical coefficients of each surface.

As illustrated in FIG. 4, an aberration of the optical imaging system 100 of the present application is still be controlled within a reasonable range on the premise of satisfying ultra-thinness and miniaturization, which ensures the imaging quality.

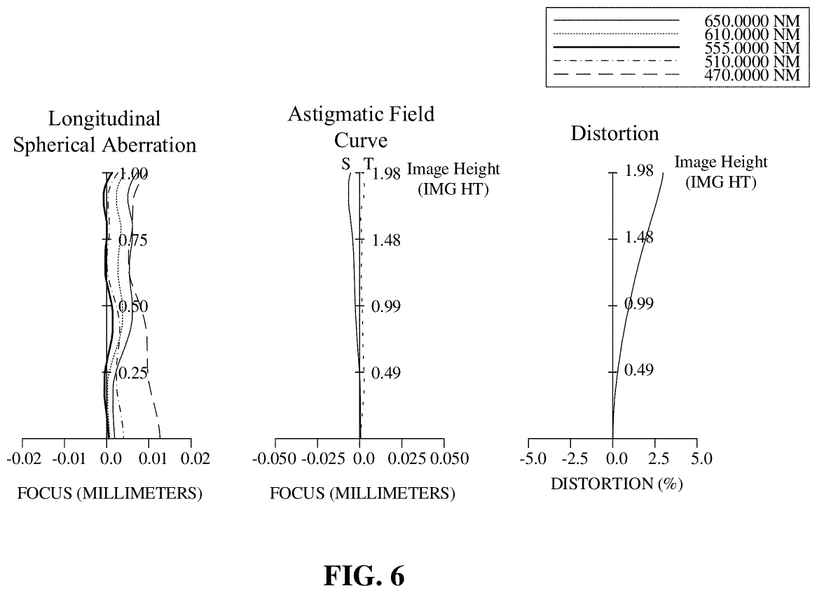

Referring to FIG. 5 and FIG. 6, FIG. 5 is a schematic structural view of an optical imaging system 100 according to an implementation of the present application. FIG. 6 illustrates from left to right a spherical aberration curve, an astigmatic curve, and a distortion curve of the optical imaging system 100 illustrated in FIG. 5. As illustrated in FIG. 5, the optical imaging system 100 of this implementation includes, from an object side to an image side, a first lens L1 with a positive refractive power, a second lens L2 with a negative refractive power, a stop 10, a first infrared filter 31, a third lens L3 with a negative refractive power, a fourth lens L4 with a positive refractive power, a protective glass 50, and an imaging surface 60.

The first lens L1 is made of plastic. An object-side surface S1 and an image-side surface S2 of the first lens L1 are aspheric. The object-side surface S1 is convex near the optical axis and a periphery. The image-side surface S2 is convex near the optical axis and a periphery.

The second lens L2 is made of plastic. An object-side surface S3 and an image-side surface S4 of the second lens L2 are aspheric. The object-side surface S3 is concave near the optical axis and a periphery. The image-side surface S4 is concave near the optical axis and a periphery.

The third lens L3 is made of plastic. An object-side surface S5 and an image-side surface S6 of the third lens L3 are aspheric. The object-side surface S5 is convex near the optical axis and is concave near a periphery. The image-side surface S6 is concave near the optical axis and is convex near a periphery.

The fourth lens L4 is made of plastic. An object-side surface S7 and an image-side surface S8 of the fourth lens L4 are aspheric. The object-side surface S7 is convex near the optical axis and a periphery. The image-side surface S8 is concave near the optical axis and is convex near a periphery.

In this implementation, FNO=2.50. BF=0.939, TTL=5.662, BF/TTL=0.166. MAX(T12:T23:T34)=1.906. f1=2.162, f=4.177, f1/f=0.518. R1=1.669, R1/f=0.400. D=3.298, CT4=0.952, D/CT4=3.464. R7=3.364, R8=4.345, |(R7−R8)/(R7−FR8)|=0.127.

In this implementation, the optical imaging system 100 satisfies conditions in Table 5 and Table 6 below.

TABLE 5
Optical Imaging System 100 Illustrated in FIG. 5
EFL = 4.177, FNO = 2.50, FOV = 36.0, TTL = 5.662

| Surface | Surface | Surface | Y | | | Refractive | Abbe | Focal |
|---|---|---|---|---|---|---|---|---|
| Number | name | type | Radius | Thickness | Material | index | number | length |
| Object surface | | Spheric | Infinity | 30.00 | | | | |
| S1 | First Lens | Aspheric | 1.669 | 0.979 | Plastic | 1.544 | 56.114 | 2.162 |
| S2 | | Aspheric | −3.193 | 0.104 | | | | |
| S3 | Second Lens | Aspheric | −3.062 | 0.392 | Plastic | 1.640 | 23.530 | −3.347 |
| S4 | | Aspheric | 7.668 | 0.191 | | | | |
| Stop 10 | | Spheric | Infinity | 0.309 | | | | |
| S9 | First Infrared | Spheric | Infinity | 0.300 | Glass | 1.517 | 64.167 | |
| S10 | Filter | Spheric | Infinity | 1.106 | | | | |
| S5 | Third Lens | Aspheric | 9.019 | 0.229 | Plastic | 1.544 | 56.114 | −4.641 |
| S6 | | Aspheric | 1.960 | 0.100 | | | | |
| S7 | Fourth Lens | Aspheric | 3.364 | 0.952 | Plastic | 1.640 | 23.530 | 16.756 |
| S8 | | Aspheric | 4.345 | 0.463 | | | | |
| S51 | Protective | Spheric | Infinity | 0.400 | Glass | 1.517 | 64.167 | |
| S53 | glass | Spheric | Infinity | 0.138 | | | | |
| Imaging Surface | | Spheric | Infinity | 0.000 | | | | |

Note:
a reference wavelength is d-line 555.0 nm

TABLE 6
Aspheric Coefficients of Optical Imaging System 100 Illustrated in FIG. 5
Aspheric Coefficients

| Surface | | | | | | | | |
|---|---|---|---|---|---|---|---|---|
| Number | S1 | S2 | S3 | S4 | S5 | S6 | S7 | S8 |
| K | −3.3574E−01 | −1.0068E+01 | −3.8205E+01 | 2.0768E+00 | 6.2067E+01 | −1.1995E+01 | −4.7152E+01 | −6.4932E+00 |
| A4 | 3.4030E−03 | 8.5193E−02 | 2.0727E−02 | 1.0040E−01 | −2.1857E−01 | −1.3312E−02 | 7.3789E−02 | −7.1017E−02 |
| A6 | 2.0058E−03 | −1.5152E−01 | 8.5402E−03 | −7.9423E−02 | −3.2520E−02 | −2.4598E−01 | −2.1503E−01 | 3.2168E−02 |
| A8 | −5.3582E−03 | 2.0691E−01 | −4.4765E−02 | 1.2632E−01 | 8.2791E−02 | 4.3494E−01 | 3.1398E−01 | −1.7759E−02 |
| A10 | 6.5573E−03 | −2.0656E−01 | 1.1957E−01 | 1.0014E−03 | −3.8794E−02 | −4.0352E−01 | −2.5794E−01 | 1.1087E−02 |
| A12 | −7.6672E−03 | 1.2847E−01 | −1.5329E−01 | −2.0074E−01 | −9.2747E−02 | 2.0950E−01 | 1.2023E−01 | −4.6776E−03 |
| A14 | 4.3886E−03 | −4.5449E−02 | 9.8880E−02 | 2.4545E−01 | 1.1035E−01 | −5.8202E−02 | −3.0074E−02 | 1.0123E−03 |
| A16 | −1.4848E−03 | 6.8168E−03 | −2.4752E−02 | −8.7554E−02 | −3.7833E−02 | 6.7694E−03 | 3.1298E−03 | −8.8393E−05 |
| A18 | 0.0000E+00 | 0.0000E+00 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 | 0.0000E+00 | 0.0000E+00 |

Table 6 illustrates aspherical data of the optical imaging system 100 illustrated in FIG. 5, where k represents a conic coefficient of each surface. A4 to A20 represent the fourth to twentieth order aspherical coefficients of each surface.

As illustrated in FIG. 6, an aberration of the optical imaging system 100 of the present application is still be controlled within a reasonable range on the premise of satisfying ultra-thinness and miniaturization, which ensures the imaging quality.

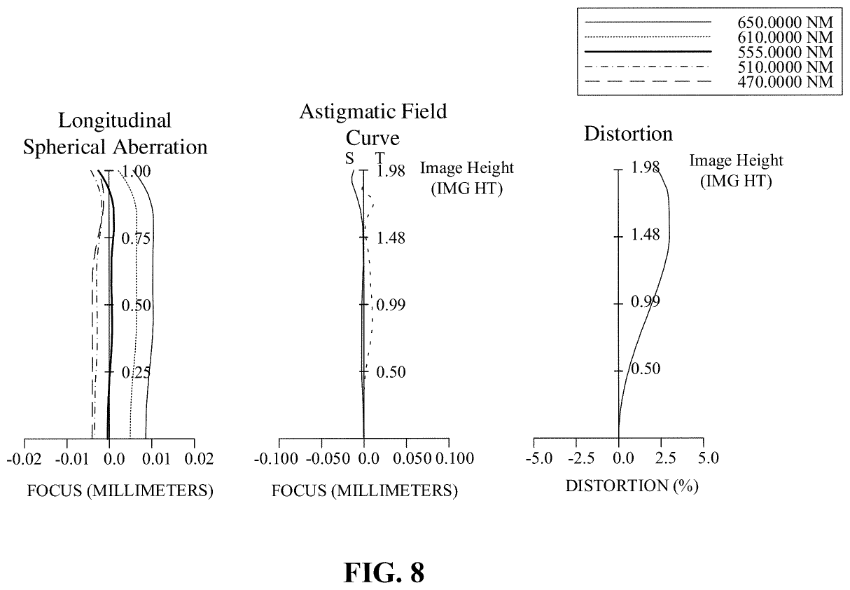

Referring to FIG. 7 and FIG. 8, FIG. 7 is a schematic structural view of an optical imaging system 100 according to an implementation of the present application. FIG. 8 illustrates from left to right a spherical aberration curve, an astigmatic curve, and a distortion curve of the optical imaging system 100 illustrated in FIG. 7. As illustrated in FIG. 7, the optical imaging system 100 of this implementation includes, from an object side to an image side, a third infrared filter 35, a first lens L1 with a positive refractive power, a second lens L2 with a negative refractive power, a stop 10, a first infrared filter 31, a third lens L3 with a negative refractive power, a fourth lens L4 with a negative refractive power, a protective glass 50, and an imaging surface 60.

The first lens L1 is made of plastic. An object-side surface S1 and an image-side surface S2 of the first lens L1 are aspheric. The object-side surface S1 is convex near the optical axis and a periphery. The image-side surface S2 is convex near the optical axis and a periphery.

The second lens L2 is made of plastic. An object-side surface S3 and an image-side surface S4 of the second lens L2 are aspheric. The object-side surface S3 is concave near the optical axis and a periphery. The image-side surface S4 is concave near the optical axis and a periphery.

The third lens L3 is made of plastic. An object-side surface S5 and an image-side surface S6 of the third lens L3 are aspheric. The object-side surface S5 is convex near the optical axis and is concave near a periphery. The image-side surface S6 is concave near the optical axis and is convex near a periphery.

The fourth lens L4 is made of plastic. An object-side surface S7 and an image-side surface S8 of the fourth lens L4 are aspheric. The object-side surface S7 is convex near the optical axis and is concave near a periphery. The image-side surface S8 is concave near the optical axis and is convex near a periphery.

In this implementation, FNO=2.50. BF=0.842, TTL=5.2, BF/TTL=0.162. MAX(T12:T23:T34)=1.693. f1=2.147, f=3.746, f1/f=0.573. R1=1.515, R1/f=0.404. D=3.602, CT4=0.4, D/CT4=9.005. R7=2.421, R8=2.084, |(R7−R8)/(R7+R8)|=0.075.

In this implementation, the optical imaging system 100 satisfies conditions in Table 7 and Table 8 below.

TABLE 7
Optical Imaging System 100 Illustrated in FIG. 7
EFL = 3.746, FNO = 2.5, FOV = 42.2, TTL = 5.2

| Surface | Surface | Surface | Y | | | Refractive | Abbe | Focal |
|---|---|---|---|---|---|---|---|---|
| Number | name | type | Radius | Thickness | Material | index | number | length |
| Object surface | | Spheric | Infinity | 30.00 | | | | |
| S13 | Third Infrared | Spheric | Infinity | 0.210 | Glass | 1.517 | 64.167 | |
| S14 | Filter | Spheric | Infinity | 0.100 | | | | |
| S1 | First Lens | Aspheric | 1.515 | 0.917 | Plastic | 1.544 | 56.114 | 2.147 |
| S2 | | Aspheric | −4.073 | 0.103 | | | | |
| S3 | Second Lens | Aspheric | −4.013 | 0.373 | Plastic | 1.640 | 23.530 | −3.572 |
| S4 | | Aspheric | 5.597 | 0.100 | | | | |
| Stop 10 | | | Infinity | 0.248 | | | | |
| S9 | First Infrared | Spheric | Infinity | 0.300 | Glass | 1.517 | 64.167 | |
| S10 | Filter | Spheric | Infinity | 1.045 | | | | |
| S5 | Third Lens | Aspheric | 8.450 | 0.272 | Plastic | 1.544 | 56.114 | −7.865 |
| S6 | | Aspheric | 2.814 | 0.108 | | | | |
| S7 | Fourth Lens | Aspheric | 2.421 | 0.400 | Plastic | 1.640 | 23.530 | −43.309 |
| S8 | | Aspheric | 2.084 | 0.428 | | | | |
| S51 | Protective | Spheric | Infinity | 0.400 | Glass | 1.517 | 64.167 | |
| S53 | Glass | Spheric | Infinity | 0.195 | | | | |
| Imaging Surface | | Spheric | Infinity | 0.000 | | | | |

Note:
a reference wavelength is d-line 555.0 nm

TABLE 8
Aspheric Coefficients of Optical Imaging System 100 Illustrated in FIG. 7
Aspheric Coefficients

| Surface | | | | | | | | |
|---|---|---|---|---|---|---|---|---|
| Number | S1 | S2 | S3 | S4 | S5 | S6 | S7 | S8 |
| K | −3.1367E−01 | −9.6413E+00 | −4.0812E+01 | 2.6528E+00 | −9.9786E+00 | −7.5272E+00 | −2.5829E+01 | −8.4087E+00 |
| A4 | 4.3206E−03 | 6.7600E−02 | 4.1368E−02 | 8.1461E−02 | −1.4414E−01 | −8.4473E−02 | 4.4998E−02 | −9.2574E−02 |
| A6 | 4.6347E−03 | −1.2988E−01 | −9.4890E−02 | 2.1317E−04 | −3.4033E−01 | 3.8614E−02 | −1.0978E−01 | 4.7941E−02 |
| A8 | −1.3969E−02 | 2.1865E−01 | 2.1564E−01 | −2.5093E−01 | 1.1614E+00 | −2.1547E−01 | 1.2569E−01 | −1.6701E−02 |
| A10 | 2.3378E−02 | −2.6773E−01 | −2.3553E−01 | 1.6479E+00 | −2.8060E+00 | 3.1662E−01 | −7.1656E−02 | 7.5024E−03 |
| A12 | −2.3008E−02 | 2.0451E−01 | 1.0411E−01 | −4.1283E+00 | 3.7649E+00 | −2.1926E−01 | 2.1252E−02 | −3.2835E−03 |
| A14 | 1.0749E−02 | −8.6974E−02 | 3.6881E−02 | 5.1572E+00 | −2.6500E+00 | 7.2176E−02 | −2.8838E−03 | 8.6346E−04 |
| A16 | −2.6147E−03 | 1.5322E−02 | −3.8684E−02 | −2.6182E+00 | 7.4857E−01 | −8.9013E−03 | 9.2291E−05 | −1.0424E−04 |
| A18 | 0.0000E+00 | 0.0000E+00 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 | 0.0000E+00 | 0.0000E+00 |

Table 8 illustrates aspherical data of the optical imaging system 100 illustrated in FIG. 7, where k represents a conic coefficient of each surface. A4 to A20 represent the fourth to twentieth order aspherical coefficients of each surface.

As illustrated in FIG. 8, an aberration of the optical imaging system 100 of the present application is still be controlled within a reasonable range on the premise of satisfying ultra-thinness and miniaturization, which ensures the imaging quality.

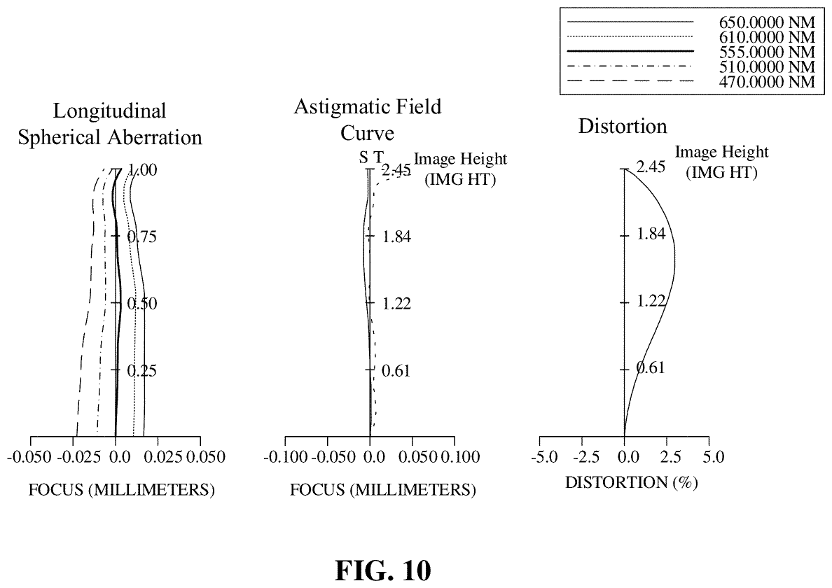

Referring to FIG. 9 and FIG. 10, FIG. 9 is a schematic structural view of an optical imaging system 100 according to an implementation of the present application. FIG. 10 illustrates from left to right a spherical aberration curve, an astigmatic curve, and a distortion curve of the optical imaging system 100 illustrated in FIG. 9. As illustrated in FIG. 9, the optical imaging system 100 of this implementation includes, from an object side to an image side, a stop 10, a first lens L1 with a positive refractive power, a first infrared filter 31, a second lens L2 with a negative refractive power, a third lens L3 with a positive refractive power, a fourth lens L4 with a negative refractive power, a second infrared filter 33, and an imaging surface 60.

The first lens L1 is made of plastic. An object-side surface S1 and an image-side surface S2 of the first lens L1 are aspheric. The object-side surface S1 is convex near the optical axis and a periphery. The image-side surface S2 is convex near the optical axis and a periphery.

The second lens L2 is made of plastic. An object-side surface S3 and an image-side surface S4 of the second lens L2 are aspheric. The object-side surface S3 is convex near the optical axis and is concave near a periphery. The image-side surface S4 is concave near the optical axis and a periphery.

The third lens L3 is made of plastic. An object-side surface S5 and an image-side surface S6 of the third lens L3 are aspheric. The object-side surface S5 is concave near the optical axis and a periphery. The image-side surface S6 is convex near the optical axis and a periphery.

The fourth lens L4 is made of plastic. An object-side surface S7 and an image-side surface S8 of the fourth lens L4 are aspheric. The object-side surface S7 is convex near the optical axis and is concave near a periphery. The image-side surface S8 is concave near the optical axis and is convex near a periphery.

In this implementation, FNO=2.40. BF=0.8, TTL=3.946, BF/TTL=0.203. MAX(T12:T23:T34)=0.41. f1=3.153, f=2.941, f1/f=1.072. R1=1.911, R1/f=0.650. D=3.976, CT4=0.431, D/CT4=9.225. R7=2.116, R8=0.695, |(R7−R8)/(R7+R8)|=0.506.

In this implementation, the optical imaging system 100 satisfies conditions in Table 9 and Table 10 below.

TABLE 9
Optical Imaging System 100 Illustrated in FIG. 9
EFL = 2.941, FNO = 2.4, FOV = 29.0, TTL = 3.946

| Surface | Surface | Surface | Y | | | Refractive | Abbe | Focal |
|---|---|---|---|---|---|---|---|---|
| Number | name | type | Radius | Thickness | Material | index | number | length |
| Object surface | | Spheric | Infinity | 400 | | | | |
| Stop 10 | | Spheric | Infinity | −0.055 | | | | |
| S1 | First Lens | Aspheric | 1.911 | 0.564 | Plastic | 1.544 | 56.114 | 3.153 |
| S2 | | Aspheric | −15.546 | 0.100 | | | | |
| S9 | First Infrared | Aspheric | Infinity | 0.210 | Glass | 1.517 | 64.167 | |
| S10 | Filter | Aspheric | Infinity | 0.100 | | | | |
| S3 | Second Lens | Aspheric | 3.182 | 0.224 | Plastic | 1.661 | 20.368 | −11.134 |
| S4 | | Aspheric | 2.164 | 0.321 | | | | |
| S5 | Third Lens | Aspheric | −3.298 | 0.792 | Plastic | 1.544 | 56.114 | 2.178 |
| S6 | | Aspheric | −0.948 | 0.103 | | | | |
| S7 | Fourth Lens | Asnheric | 2.116 | 0.431 | Plastic | 1.544 | 56.114 | −2.123 |
| S8 | | Aspheric | 0.695 | 0.542 | | | | |
| S11 | Second Infrared | Spheric | Infinity | 0.210 | Glass | 1.517 | 64.167 | |
| S12 | Filter | Spheric | Infinity | 0.350 | | | | |
| Imaging Surface | | Spheric | Infinity | 0.000 | | | | |

Note:
a reference wavelength is d-line 555.0 nm

TABLE 10
Aspheric Coefficients of the Optical Imaging System 100 Illustrated in FIG. 9 Aspheric Coefficients

| Surface | | | | | | | | |
|---|---|---|---|---|---|---|---|---|
| Number | S1 | S2 | S3 | S4 | S5 | S6 | S7 | S8 |
| K | −1.5841E−01 | −9.9000E+01 | −6.7831E+00 | 1.8672E+00 | 1.0913E+01 | −4.3939E+00 | −2.9890E+01 | −3.9274E+00 |
| A4 | −9.3232E−02 | −2.6630E−01 | −3.4450E−01 | −1.8531E−01 | 2.2854E−01 | −2.6350E−01 | −2.7429E−01 | −2.6156E−01 |
| A6 | 3.0564E−01 | 1.2107E−01 | −3.0861E−01 | −6.6682E−01 | −6.1152E−01 | 5.0762E−01 | −2.4746E−02 | 2.7439E−01 |
| A8 | −7.2703E+00 | −1.2899E+00 | 1.8670E+00 | 3.7250E+00 | 2.1100E+00 | −8.0693E−01 | 4.8805E−01 | −2.2367E−01 |
| A10 | 7.0786E+01 | 6.4077E+00 | −7.7276E+00 | −1.4109E+01 | −6.0302E+00 | 6.3744E−01 | −8.4150E−01 | 1.2931E−01 |
| A12 | −4.0820E+02 | −2.0373E+01 | 2.6022E+01 | 3.8084E+01 | 1.2283E+01 | 6.2126E−01 | 7.9648E−01 | −5.1867E−02 |
| A14 | 1.4155E+03 | 4.2615E+01 | −4.8906E+01 | −6.4945E+01 | −1.7636E+01 | −2.1700E+00 | −4.4375E−01 | 1.4075E−02 |
| A16 | −2.9044E+03 | −5.6968E+01 | 5.1745E+01 | 6.7402E+01 | 1.7464E+01 | 2.3496E+00 | 1.4478E−01 | −2.4682E−03 |
| A18 | 3.2441E+03 | 4.3850E+01 | −2.9954E+01 | −3.9036E+01 | −1.0317E+01 | −1.1770E+00 | −2.5733E−02 | 2.5380E−04 |
| A20 | −1.5193E+03 | −1.4828E+01 | 7.4782E+00 | 9.6035E+00 | 2.6226E+00 | 2.2710E−01 | 1.9327E−03 | −1.1724E−05 |

Table 10 illustrates aspherical data of the optical imaging system 100 illustrated in FIG. 9, where k represents a conic coefficient of each surface. A4 to A20 represent the fourth to twentieth order aspherical coefficients of each surface.

As illustrated in FIG. 10, an aberration of the optical imaging system 100 of the present application is still be controlled within a reasonable range on the premise of satisfying ultra-thinness and miniaturization, which ensures the imaging quality.

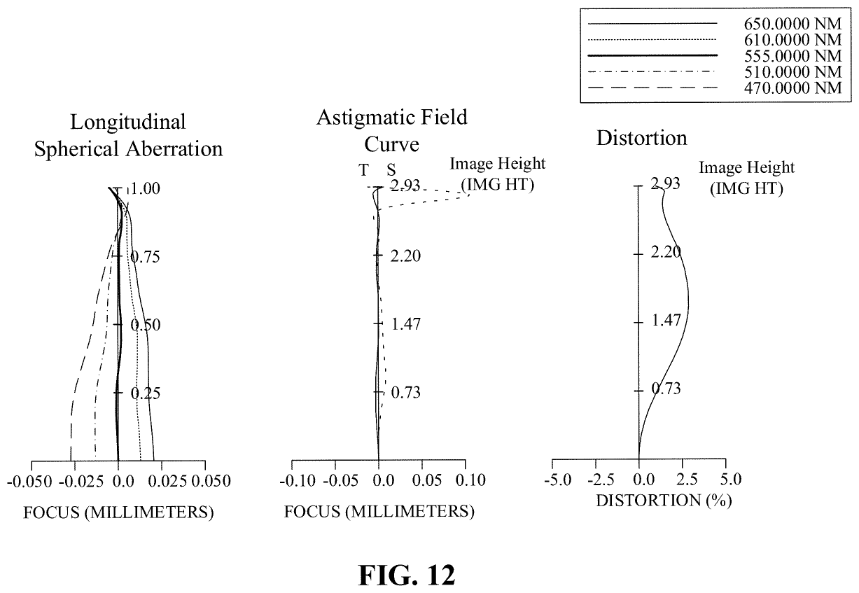

Referring to FIG. 11 and FIG. 12, FIG. 11 is a schematic structural view of an optical imaging system 100 according to an implementation of the present application. FIG. 12 illustrates from left to right a spherical aberration curve, an astigmatic curve, and a distortion curve of the optical imaging system 100 illustrated in FIG. 11. As illustrated in FIG. 11, the optical imaging system 100 of this implementation includes, from an object side to an image side, a first lens L1 with a positive refractive power, a second lens L2 with a negative refractive power, a first infrared filter 31, a third lens L3 with a positive refractive power, a first infrared filter 31, a fourth lens L4 with a negative refractive power, a second infrared filter 33, and an imaging surface 60. The optical imaging system 100 further includes a stop 10. The stop 10 is located at an object side of the first lens L1.

The first lens L1 is made of plastic. An object-side surface S1 and an image-side surface S2 of the first lens L1 are aspheric. The object-side surface S1 is convex near the optical axis and a periphery. The image-side surface S2 is concave near the optical axis and a periphery.

The second lens L2 is made of plastic. An object-side surface S3 and an image-side surface S4 of the second lens L2 are aspheric. The object-side surface S3 is convex near the optical axis and is concave near a periphery. The image-side surface S4 is concave near the optical axis and a periphery.

The third lens L3 is made of plastic. An object-side surface S5 and an image-side surface S6 of the third lens L3 are aspheric. The object-side surface S5 is concave near the optical axis and a periphery. The image-side surface S6 is convex near the optical axis and a periphery.

The fourth lens L4 is made of plastic. An object-side surface S7 and an image-side surface S8 of the fourth lens L4 are aspheric. The object-side surface S7 is convex near the optical axis and a periphery. The image-side surface S8 is concave near the optical axis and is convex near a periphery.

In this implementation, FNO=2.20. BF=0.8, TTL=4.669, BF/TTL=0.171. MAX(T12:T23:T34)=0.986. f1=3.814, f=3.945, f1/f=0.967. R1=1.422, R1/f=0.360. D=5.306, CT4=0.424, D/CT4=12.514. R7=1.376, R8=0.994, |(R7−R8)/(R7+R8)|=0.161.

In this implementation, the optical imaging system 100 satisfies conditions in Table 11 and Table 12 below.

TABLE 11
Optical Imaging System 100 Illustrated in FIG. 11
EFL = 3.945, FNO = 2.2, FOV = 72.2, TTL = 4.669

| Surface | Surface | Surface | Y | | | Refractive | Abbe | Focal |
|---|---|---|---|---|---|---|---|---|
| Number | name | type | Radius | Thickness | Material | index | number | length |
| Object surface | | Spheric | Infinity | Infinity | | | | |
| Stop 10 | | Spheric | Infinity | −0.309 | | | | |
| S1 | First Lens | Aspheric | 1.422 | 0.498 | Plastic | 1.544 | 56.114 | 3.814 |
| S2 | | Aspheric | 3.932 | 0.120 | | | | |
| S3 | Second Lens | Aspheric | 2.773 | 0.274 | Plastic | 1.640 | 23.530 | −9.103 |
| S4 | | Aspheric | 1.810 | 0.349 | | | | |
| S9 | First Infrared | Spheric | Infinity | 0.110 | Glass | 1.517 | 64.167 | |
| S10 | Filter | Spheric | Infinity | 0.317 | | | | |
| S5 | Third Lens | Aspheric | −3.617 | 0.439 | Plastic | 1.544 | 56.114 | 7.865 |
| S6 | | Aspheric | −2.047 | 0.218 | | | | |
| S9 | First Infrared | Spheric | Infinity | 0.300 | Glass | 1.517 | 64.167 | |
| S10 | Filter | Spheric | Infinity | 0.468 | | | | |
| S7 | Fourth Lens | Aspheric | 1.376 | 0.424 | Plastic | 1.544 | 56.114 | −10.779 |
| S8 | | Aspheric | 0.994 | 0.353 | | | | |
| S11 | Second Infrared | Spheric | Infinity | 0.210 | Glass | 1.517 | 64.167 | |
| S12 | Filter | Spheric | Infinity | 0.588 | | | | |
| Imaging Surface | | Spheric | Infinity | 0.000 | | | | |

Note:
a reference wavelength is d-line 555.0 nm

TABLE 12
Aspheric Coefficients of the Optical Imaging System 100 Illustrated in FIG. 11
Aspheric Coefficients

| Surface | | | | | | | | |
|---|---|---|---|---|---|---|---|---|
| Number | S1 | S2 | S3 | S4 | S5 | S6 | S7 | S8 |
| K | −5.8037E+00 | 3.9470E+00 | −2.5076E+01 | −4.0629E+00 | 4.9934E+00 | −1.9618E+00 | −4.0734E+00 | −1.9253E+00 |
| A4 | 2.6155E−01 | −1.7152E−01 | −1.3466E−01 | −2.9771E−02 | −1.1979E−01 | −1.8410E−01 | −1.7154E−01 | −2.4288E−01 |
| A6 | −2.5116E−01 | 2.1462E−01 | −3.8630E−02 | 4.7641E−02 | 8.2320E−02 | 2.2935E−01 | 1.2833E−02 | 1.4368E−01 |
| A8 | 5.1725E−01 | −2.6730E−01 | 6.2183E−01 | 5.6757E−01 | −1.5022E−01 | −6.0233E−01 | 4.2816E−02 | −6.2944E−02 |
| A10 | −8.8733E−01 | 5.8961E−01 | −1.3664E+00 | −1.5606E+00 | 3.2004E−01 | 1.2670E+00 | −2.6214E−02 | 2.0051E−02 |
| A12 | 1.1078E+00 | −1.1425E+00 | 1.4451E+00 | 2.3772E+00 | −6.1686E−01 | −1.7264E+00 | 8.0768E−03 | −4.4146E−03 |
| A14 | −7.6132E−01 | 1.2711E+00 | −7.1331E−01 | −2.0306E+00 | 9.6883E−01 | 1.4211E+00 | −1.5025E−03 | 6.3457E−04 |
| A16 | 2.2780E−01 | −6.1001E−01 | 0.0000E+00 | 7.6353E−01 | −7.4626E−01 | −6.1580E−01 | 1.7014E−04 | −5.4890E−05 |
| A18 | 0.0000E+00 | 0.0000E+00 | 0.0000E+00 | 0.0000E+00 | 2.0835E−01 | 1.0630E−01 | −1.0815E−05 | 2.4791E−06 |
| A20 | 0.0000E+00 | 0.0000E+00 | 0.0000E+00 | 0.0000E+00 | 0.0000E+00 | 0.0000E+00 | 2.9577E−07 | −4.1498E−08 |

Table 12 illustrates aspherical data of the optical imaging system 100 illustrated in FIG. 11, where k represents a conic coefficient of each surface. A4 to A20 represent the fourth to twentieth order aspherical coefficients of each surface.

As illustrated in FIG. 12, an aberration of the optical imaging system 100 of the present application is still be controlled within a reasonable range on the premise of satisfying ultra-thinness and miniaturization, which ensures the imaging quality.

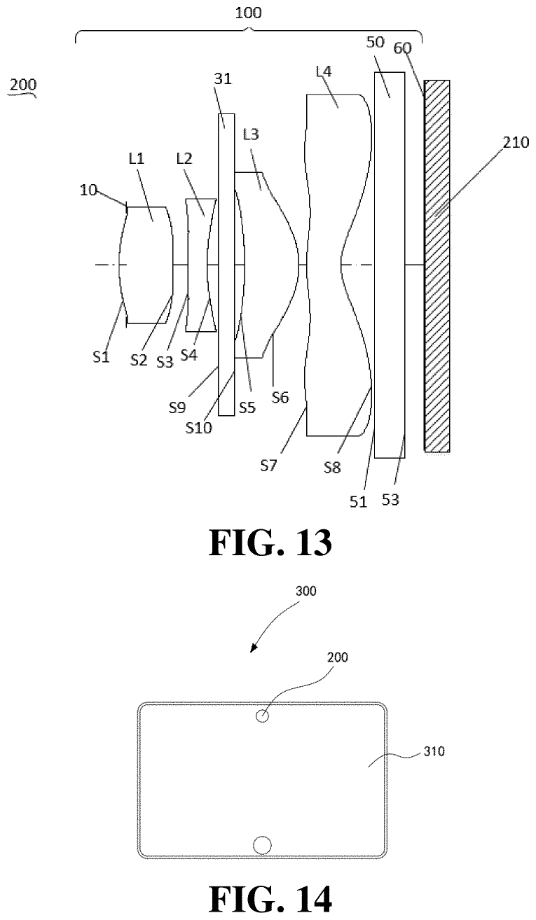

Referring to FIG. 13, in a second aspect of the present application, an image capturing apparatus 200 is provided. The image capturing apparatus 200 includes the optical imaging system 100 as described in the first aspect and a photosensitive element 210 located on an imaging surface 60 of the optical imaging system 100.

The photosensitive element 210 of the present application may be a charge coupled device (CCD) or a complementary metal-oxide semiconductor (CMOS sensor).

As for other features of the image capturing apparatus 200, reference can be made to the first aspect of the present application, which is not repeated herein.

As can be seen in FIG. 14, in a third aspect of the present application, an electronic device 300 is provided. The electronic device 300 includes a body 310 and the image capturing apparatus 200 as described in the second aspect. The image capturing apparatus 200 is installed on the body 310.

The electronic device 300 in the present application can include but is not limited to personal computers, laptops, tablet personal computers, a mobile phone, cameras, intelligent bands, intelligent watches, and intelligent glasses, etc.

While present application has been described specifically and in detail above with reference to several implementations, the scope of the present application is not limited thereto. As will occur to those skilled in the art, present application is susceptible to various modifications and substitution within the technical range of the present application. Any modifications or substitutions that can be made by those skilled in the art shall all be encompassed within the protection of the present application. Therefore, the scope of the present application should be determined by the scope of the claims.

What is claimed is:

1. An optical imaging system comprising, in order from an object side to an image side:
a first lens with a positive refractive power;
a second lens with a refractive power;
a third lens with a refractive power; and
a fourth lens with a refractive power;
the optical imaging system further comprising:
a stop located in front of an imaging surface of the optical imaging system; and
a first infrared filter located between the first lens and the fourth lens.

2. The optical imaging system of claim 1, wherein an object-side surface and an image-side surface of each of the first lens, the second lens, the third lens, and the fourth lens are aspheric, and at least one of the object-side surface or the image-side surface of the fourth lens has at least one inflection point.

3. The optical imaging system of claim 1, wherein an object-side surface of the first lens is convex near an optical axis and a periphery.

4. The optical imaging system of claim 1, wherein an image-side surface of the second lens is concave near an optical axis and a periphery.

5. The optical imaging system of claim 1, wherein an object-side surface of the third lens is concave near a periphery, and an image-side surface of the third lens is convex near a periphery.

6. The optical imaging system of claim 1, an object-side surface of the fourth lens is convex near the optical axis, and an image-side surface of the fourth lens is concave near the optical axis and is convex near a periphery.

7. The optical imaging system of claim 1, further comprising a protective glass or a second infrared filter, wherein the protective glass or the second infrared filter is located between the fourth lens and the imaging surface.

8. The optical imaging system of claim 7, further comprising a third infrared filter located in front of the first lens.

9. The optical imaging system of claim 7, wherein the first infrared filter comprises at least one first infrared filter.

10. The optical imaging system of claim 7, wherein the optical imaging system satisfies the following expression:
FNO>2.0;
wherein FNO represents an f-number of the optical imaging system.

11. The optical imaging system of claim 7, wherein the optical imaging system satisfies the following expression:
BF/TTL<0.21;
wherein BF represents a minimum distance from an image-side surface of the fourth lens to the imaging surface of the optical imaging system in a direction parallel to an optical axis, and TTL represents a distance from an object-side surface of the first lens to the imaging surface on the optical axis.

12. The optical imaging system of claim 7, wherein the optical imaging system satisfies the following expression:
MAX(T12:T23:T34)>0.4;
wherein T12 represents a distance from an image-side surface of the first lens to an object-side surface of the second lens on an optical axis, T23 represents a distance from an image-side surface of the second lens to an object-side surface of the third lens on the optical axis, T34 represents a distance from an image-side surface of the third lens to an object-side surface of the fourth lens on the optical axis, and MAX(T12:T23:T34) represents a maximum among T12, 123, and T34.

13. The optical imaging system of claim 7, wherein the optical imaging system satisfies the following expression:
0.5<f1/f<1.3;
wherein f represents an effective focal length of the optical imaging system, and f1 represents an effective focal length of the first lens.

14. The optical imaging system of claim 7, wherein the optical imaging system satisfies the following expression:
R/f>0.4;
wherein R1 represents a radius of curvature of an object-side surface of the first lens, and f represents a total effective focal length of the optical imaging system.

15. The optical imaging system of claim 7, wherein the optical imaging system satisfies the following expression:
3<D/CT4<15;
wherein D represents an optical clear aperture of an image-side surface of the fourth lens, and CT4 represents a distance from an object-side surface of the fourth lens to the image-side surface of the fourth lens on an optical axis.

16. The optical imaging system of claim 7, wherein the optical imaging system satisfies the following expression:
0.12<|(R7−R8)/(R7+R8)|<0.51;
wherein R7 represents a radius of curvature of an object-side surface of the fourth lens, and R8 represents a radius of curvature of an image-side surface of the fourth lens.

17. The optical imaging system of claim 1, wherein at least one of the second lens, the third lens, or the fourth lens has a negative refractive power.

18. An image capturing apparatus, comprising:
an optical imaging system comprising, in order from an object side to an image side:
a first lens with a positive refractive power;
a second lens with a refractive power;
a third lens with a refractive power; and
a fourth lens with a refractive power;
the optical imaging system further comprising:
a stop located in front of an imaging surface of the optical imaging system; and
a first infrared filter located between the first lens and the fourth lens; and
a photosensitive element located on the imaging surface of the optical imaging system.

19. The image capturing apparatus of claim 18, wherein an object-side surface and an image-side surface of each of the first lens, the second lens, the third lens, and the fourth lens are aspheric, and at least one of the object-side surface or the image-side surface of the fourth lens has at least one inflection point.

20. An electronic device, comprising:
a body; and
the image capturing apparatus of claim 18, wherein the image capturing apparatus is installed on the body.
